(19) United States
(12) Patent Application Publication
(10) Pub. No.: US 2022/0071450 A1
(43) Pub. Date: Mar. 10, 2022

(54) ELECTRICALLY OPERATED KITCHEN APPLIANCE COMPRISING AN ELECTRICAL INTERFACE FOR A PREPARATION VESSEL

(71) Applicant: Vorwerk & Co. Interholding GmbH, Wuppertal (DE)

(72) Inventors: Stephan POHL, Wuppertal (DE); Torsten LANG, Solingen (DE); Dietmar MEHLHASE, Koeln (DE)

(73) Assignee: Vorwerk & Co. Interholding GmbH, Wuppertal (DE)

(21) Appl. No.: 17/466,028

(22) Filed: Sep. 3, 2021

(30) Foreign Application Priority Data
Sep. 4, 2020 (DE) 10 2020 123 218.7

(51) Int. Cl. A47J 43/07; A47J 43/046; H01R 29/00

(52) U.S. Cl. CPC A47J 43/0761; H01R 29/00; A47J 43/0727; A47J 43/046

(57) ABSTRACT

An electrically operated kitchen appliance includes at least two functional elements for performing a function of the kitchen appliance and has a receiving region for holding a preparation vessel. The receiving region has an electrical interface with electrical contact elements that are electrically connected to a functional element of the kitchen appliance, and establish an electrically conductive connection to corresponding contact elements of a preparation vessel, which is connected to the receiving region. The kitchen appliance has a switch-over device, which is assigned to the electrical contact elements and which changes a connection assignment between the electrical contact elements of the kitchen appliance and the functional elements of the kitchen appliance in such a way that after the actuation of the switch-over device, a functional element is connected to a different electrical contact element than prior to the actuation of the switch-over device.

### CROSS REFERENCE TO RELATED APPLICATIONS

Applicant claims priority under 35 U.S.C. § 119 of German Application No. 10 2020 123 218.7 filed Sep. 4, 2020, the disclosure of which is incorporated by reference.

### BACKGROUND OF THE INVENTION

### 1. Field of the Invention

The invention elates to an electrically operated kitchen appliance comprising at least two functional means for performing a function of the kitchen appliance and comprising a receiving region for holding a preparation vessel, wherein the receiving region has an electrical interface comprising a plurality of electrical contact elements, wherein the electrical contact elements are in each case connected in an electrically conductive manner to a functional means of the kitchen appliance on the one hand, and are configured on the other hand to establish an electrically conductive connection to corresponding electrical vessel contact elements of a preparation vessel, which is connected to the receiving region.

### 2. Description of the Related Art

Electrically operated kitchen appliances and preparation vessels for them are known in the prior art. An appliance housing usually has a receiving region, to which the preparation vessel can be connected in a certain orientation. The receiving region can in particular be formed in the manner of a cavity, into which the preparation vessel can be inserted in a form-corresponding manner, in particular in such a way that the preparation vessel is aligned both with reference to a vertical direction and with reference to a circumferential direction of the preparation vessel in the course of the connection to the kitchen appliance.

An electrical interface, which serves for an electrical connection to means of the preparation vessel, is arranged in the receiving region. Moreover, the receiving region can for example also have a rotating shaft, which serves to drive an agitator, which is located in the preparation vessel. The agitator is driven via an electric motor on the kitchen appliance side, for example to prepare dishes.

It is furthermore known that the electrical interface, which is arranged in the receiving region, has a plurality of electrical contact elements, for example contact elements for a heater of the preparation vessel, electrical contact elements for temperature sensors, or a contact element, which is connected to a protective conductor. The preparation vessel, which is provided for a use with the kitchen appliance, has corresponding electrical vessel contact elements, which, upon connection of the preparation vessel to the electrical interface of the kitchen appliance, automatically come into contact with the electrical contact elements of the kitchen appliance, and are thus also automatically connected to the functional means of the kitchen appliance, for example a heating means or detection means.

For example the publication DE 10 2010 016 667 A1 shows an electrically operated kitchen appliance of the above-mentioned type.

In the case of the kitchen appliances as well as preparation vessels known in the prior art, it is known to design the number and arrangement of the electrical contact elements at the kitchen appliance as well as the preparation vessel so as to correspond to one another, wherein a certain order of the electrical contact elements can be specified, depending on a current model series of the kitchen appliance or preparation vessel, respectively. It is therefore possible that a preparation vessel of a new model series has a different assignment of the electrical contact elements to the functional means of the kitchen appliance than an older generation, so that, for example, an electrical contact element, which is arranged at the preparation vessel at a certain position, serves for the electrical connection to a detection means of the kitchen appliance, while in the case of an earlier generation of the preparation vessel, this position was provided for the electrical connection to a heating means.

### SUMMARY OF THE INVENTION

Based on the above-mentioned prior art, it is thus the object of the invention to form the electrically operated kitchen appliance in such a way that the functional means thereof, namely for example a heating means and a detection means, work with different preparation vessels.

To solve the above-mentioned object, it is proposed that the kitchen appliance has a switch-over means, which is assigned to the electrical contact elements and which is configured to change a connection assignment between the electrical contact elements of the kitchen appliance and the functional means of the kitchen appliance in such a way that after the actuation of the switch-over means, a certain functional means is connected to a different electrical contact element than prior to the actuation of the switch-over means.

According to the invention, the electrically operated kitchen appliance now has a switch-over means, which is configured and formed to vary electrical connecting lines between the electrical contact elements and the functional means of the kitchen appliance in such a way that they are adapted to the arrangement of electrical vessel contact elements of a preparation vessel, which is to currently be used with the kitchen appliance. In the case of one and the same kitchen appliance, it is thus possible to provide an electrical interface, by means of which two different preparation vessels can be used, the arrangements of which to one another differ from electrical vessel contact elements. The switch-over means assigned to the electrical contact elements can be actuated, for example, either by a user or automatically as a result of a detection of a certain type of a preparation vessel, which is currently connected to the kitchen appliance.

It is proposed that the functional means is a heating means for heating the preparation vessel, a detection means for detecting a temperature of the preparation vessel, or an electrical protection means. In addition to the above-mentioned functional means, the kitchen appliance can also have other functional means, which provide a certain function for the preparation vessel, for example for the detection of further parameters of the preparation vessel or of a dish or ingredient, which is present in the preparation vessel. A functional means of the kitchen appliance is a means of the kitchen appliance, which effects a certain assigned action in or at the preparation vessel. A functional element, which corresponds thereto, is usually located in or at the preparation vessel. For example, the preparation vessel can have a heating element, which can be operated by the heating means of the kitchen appliance. The heating element can be integrated, for example, into a vessel base of the preparation vessel. The heating element is, for example, an electrical resistance heating element, in particular an NTC (so-called high-temperature conductor). Via corresponding electrical contact elements, the functional means formed in the kitchen appliance supplies an electric current, which then flows through the functional element of the preparation vessel. The functional means of the kitchen appliance can likewise also have a detection means, which, via the electrical contact elements of the interface, scans an electric voltage, which is characteristic for a certain state at or within the preparation vessel and which effects a change of the electric voltage at the corresponding electrical vessel contact elements.

It is in particular proposed that the switch-over means of the kitchen appliance has an electrical circuit comprising a plurality of electrical connecting lines, which connect the electrical contact elements to the electrical functional means in a defined changeable manner. The switch-over means is preferably formed on an electrical printed circuit board (PCB) of the kitchen appliance. In this context, the electrical connecting lines are then conductor tracks, which are printed onto the printed circuit board and which connect the electrical contact elements of the interface to electrical connections of the functional means. Moreover, the switch-over means has corresponding switching elements, with the help of which the electrical connecting lines can be switched over, in order to connect, for example, either a first electrical contact element or a second electrical contact element, depending on the type of the preparation vessel, which is currently connected to the kitchen appliance, to a certain defined functional means of the kitchen appliance in an electrically conducting manner. Such a switching element of the electrical circuit can be, for example, a semiconductor switch, in particular a transistor or a diode.

It is furthermore proposed that the switch-over means has a mechanical switching element. The mechanical switching element can in particular be a switch, which can be manually actuated by a user of the kitchen appliance. The mechanical switching element can in particular be, for example, a push button, slide switch, or the like, which switches one or several electrical connecting lines between electrical contact elements of the kitchen appliance and electrical functional means of the kitchen appliance. It is in particular recommended that several electrical connecting lines are switched over simultaneously by actuating the mechanical switching element. The mechanical switching element thus interchanges the connecting lines, so that an assignment of electronic signals, which is suitable for a certain preparation vessel, is always at hand. Provided that a certain preparation vessel other than the one beforehand is connected to the kitchen appliance, the user can manually actuate the mechanical switching element and can then effect a switch-over, which is suitable for this preparation vessel, of the connecting lines, so that the functional means of the kitchen appliance or the electrical contact elements of the kitchen appliance, respectively, correspond to the electrical vessel contact elements, and the functions of the preparation vessel thus can be used optimally in connection with the kitchen appliance. As an alternative to a switch, which can be manually actuated by a user, the switch-over of the electrical connecting lines can also be attained by means of one or several mechanical bridges, which are positioned accordingly between the connecting lines. For example, a bridge can be switched for each defined preparation vessel at a certain point of the electrical circuit, in order to establish a certain connection between an electrical contact element and a certain functional means of the kitchen appliance, which corresponds to a certain arrangement of electrical vessel contact elements of the preparation vessel.

It can furthermore be provided that the kitchen appliance has a sensor for detecting a type of a preparation vessel, which is connected to the electrical interface of the kitchen appliance, wherein the switch-over means is configured to switch over the connecting assignment between the electrical contact elements and the functional means as a function of the detected type of the preparation vessel. According to this design, the kitchen appliance has a sensor for recognizing a certain type of a preparation vessel, in order to then perform an automated switch-over of electrical connections, which are suitable for this preparation vessel, at the kitchen appliance. It can be recognized in this manner, for example, whether a preparation vessel of a newer or older generation is currently used with the kitchen appliance. The sensor can be, for example, a contact sensor, magnetic sensor, or optical sensor. For example, a subregion of the preparation vessel can have a defined shape coding, which can be recognized by a contact sensor of the kitchen appliance. The contact sensor can be, for example, a switch, which can be actuated only through the subregion, which is shaped in a defined manner, for example protrusion, of the preparation vessel. The preparation vessel can furthermore have an optical code, for example a bar code or QR code, which includes an identification of the preparation vessel and which can be read out by means of a corresponding reading means of the kitchen appliance. In this sense, the sensor of the kitchen appliance is then an optical sensor, which can recognize the optical signal of the preparation vessel. The kitchen appliance can likewise also have a magnetic sensor, which can read out a corresponding magnetic code of the preparation vessel.

It can furthermore be provided that the switch-over means of the kitchen appliance has an electromagnetically acting, remote-controlled switching element. This remote-controlled switching element can in particular be a relay. This embodiment is in particular suitable in connection with an automatic detection of the type of the preparation vessel, which is currently connected to the kitchen appliance. In this sense, a recognition of the type of the preparation vessel can initially take place fully automatically, and then an automatic switch-over of the electrical connecting lines, in order to connect the functional means of the kitchen appliance to those electrical contact elements of the kitchen appliance, which the connected preparation vessel requires. A participation of a user of the kitchen appliance is thus not required. The user himself does not have to know the type of the preparation vessel and then manually initiate a switch-over of the electrical connecting lines. Instead, the adaptation of the kitchen appliance takes place fully automatically without assistance from the user or even in such a way that the user cannot even perceive the switch-over processes, which have been performed.

It is furthermore proposed that the receiving region of the kitchen appliance has a guide means, which is configured to guide a preparation vessel, which is to be connected to the receiving region, to the electrical interface in a shape-corresponding manner. The guide means can in particular be a collar, which rises from a housing top side of the kitchen appliance and into which a subregion of the preparation vessel, for example a vessel base, can be inserted. The guide means is particularly preferably formed in such a way that the preparation vessel is forced into a certain position and orientation relative to the interface of the kitchen appliance without special assistance from the user. This can take place in that the guide means has, for example, a contour, which tapers in the direction of the kitchen appliance and along which the preparation vessel glides into the correct position, following the force of gravity, namely in such a way that the electrical vessel contact elements of the preparation vessel come into electrically conductive contact with the electrical contact elements of the interface of the kitchen appliance. The guide means can generally also have a rail guide or the like. Such formations, in the case of which the user does not have to pay particular attention to the orientation, with which he connects the preparation vessel to the kitchen appliance, are always particularly preferred.

It is proposed that the receiving region additionally has a rotating shaft for the force-transmitting connection to an agitator of the preparation vessel. According to this design, the receiving region of the kitchen appliance thus does not have only one electrical interface for connection to the preparation vessel, but, on the contrary, also a rotating shaft, which can serve for the connection of an agitator of the preparation vessel. The agitator can, for example, be an agitator, which protrudes through a bottom opening of the preparation vessel into an interior of the preparation vessel and which carries a blade set or the like. The drive motor thereby sits in the kitchen appliance and drives the agitator via the rotating shaft, which protrudes outwards. Due to the connection of the preparation vessel to the receiving region of the kitchen appliance, a connection of the rotating shaft to the agitator also takes place at the same time as the connection of the electrical interface, so that the functional means of the kitchen appliance can be used optimally and completely.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a kitchen appliance according to the invention comprising a preparation vessel;

FIG. 2 shows a perspective top view onto the kitchen appliance;

FIG. 3 shows a top view onto the kitchen appliance comprising an electrical interface for the connection of the preparation vessel;

FIG. 4 shows an enlarged view of a lower subregion of the preparation vessel;

FIG. 5A shows a connection diagram for the electrical vessel contact elements of a first preparation vessel;

FIG. 5B shows a connection diagram for the electrical vessel contact elements of a second preparation vessel; and

FIG. 6 shows a switch-over means of the kitchen appliance for switching over connecting assignments between electrical contact elements of the kitchen appliance and functional means of the kitchen appliance.

### DETAILED DESCRIPTION OF PREFERRED EMBODIMENTS

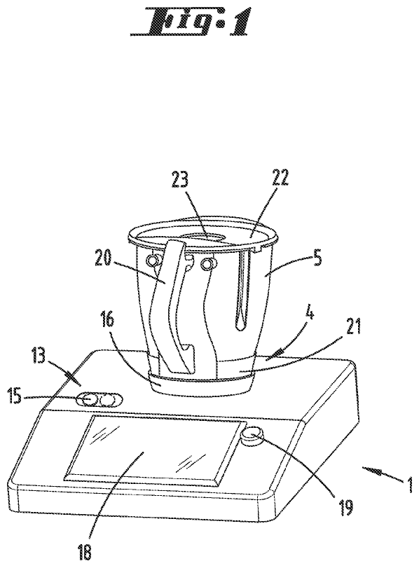

FIG. 1 shows a kitchen appliance 1, which has a receiving region 4 for connection to a preparation vessel 5. Here, the kitchen appliance 1 is formed, for example, particularly flat. The preparation vessel 5 stands on a top side of the kitchen appliance 1 and is not encompassed by the latter. The flat kitchen appliance 1 can be stowed, for example, in a particularly space-saving manner in a drawer of a kitchen in this way. The kitchen appliance 1 has a display 18 for displaying functions of the kitchen appliance 1 and optionally of recipes, which can be prepared by means of the kitchen appliance 1. A switch 19, which can serve for turning on and turning off the kitchen appliance 1 on the one hand, and for confirming input commands or the like on the other hand, is located next to the display 18. The preparation vessel 5 furthermore has, for example, a handle 20 and a vessel base 21, which serves for the connection to the receiving region 4 of the kitchen appliance 1, as well as a cover 22 closing a vessel opening, comprising a cover opening 23. For example, ingredients can be placed into the preparation vessel 5 through the cover opening 23 during an on-going preparation of the kitchen appliance 1. A mechanical switching element 15, which serves to actuate a switch-over means 13 (see FIG. 6) of the kitchen appliance 1, is furthermore located on the top side of the housing of the kitchen appliance 1. The switching element 15 can generally be located at the kitchen appliance 1 at any position, in particular on the top, on the bottom, or laterally of the housing of the kitchen appliance 1. Here, the switching element 15 is formed, for example, as mechanical slide switch, which can be displaced from a first position, which is illustrated by means of a solid line, into a second position, which is illustrated by means of a dashed line. The function of the switch-over means 13 will be described later with reference to the further figures.

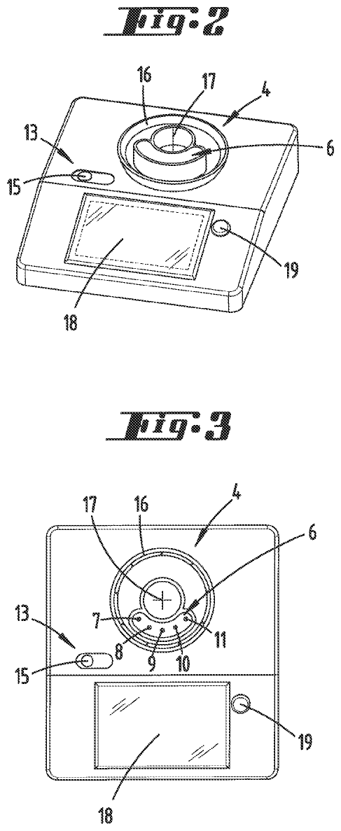

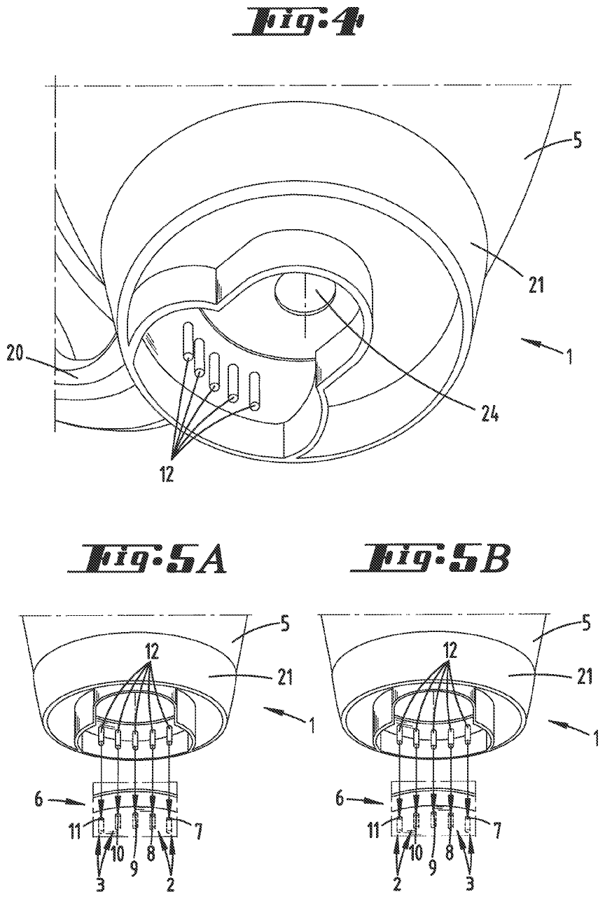

FIGS. 2 and 3 show the kitchen appliance 1 in a top view without preparation vessel 5 connected thereto. A guide means 16, which is formed here, for example, as collar, which protrudes upwards from the housing of the kitchen appliance 1, is assigned to the receiving region 4 of the preparation vessel 5. The vessel base 21 of the preparation vessel 5 can be at least partially inserted into this collar. The vessel base 21 and the guide means 16 are thereby preferably formed so as to correspond to one another in shape, so that the preparation vessel 5 is automatically forced into a defined position and orientation relative to the receiving region 4, following the force of gravity, upon connection to the kitchen appliance 1. Within the contour of the guide means 16, the receiving region 4 has an electrical interface 6 comprising a plurality of electrical contact elements 7, 8, 9, 10, 11. Concretely, the electrical interface 6 has, for example a total of five electrical contact elements 7, 8, 9, 10, 11 here. Each of the electrical contact elements 7, 8, 9, 10, 11 serves for a certain function of the kitchen appliance 1 or of the preparation vessel 5, respectively, which is connected to the kitchen appliance 1. For this purpose, each of the electrical contact elements 7, 8, 9, 10, 11 is connected to a certain functional means 2, 3 (see FIG. 6) of the kitchen appliance 1. Here, a first functional means 2 is, for example, a heating means of the kitchen appliance 1, and a second functional means 3 is, for example, a detection means for detecting a parameter of the preparation vessel 5, which is connected to the kitchen appliance 1. Here, the electrical contact elements 7, 8, 9, 10, 11 are formed, for example, in the manner of electrical sockets, into which corresponding electrical vessel contact elements 12 of the preparation vessel 5 (see FIG. 4) can be inserted. A rotating shaft 17, which is assigned to a drive motor of the kitchen appliance 1, is furthermore located in the receiving region 4 of the kitchen appliance 1. The rotating shaft 17 serves to drive an agitator, which is arranged in the preparation vessel 5 and which is configured, for example, to stir or to comminute food in the preparation vessel 5.

FIG. 4 shows a lower subregion of the preparation vessel 5 comprising the vessel base 21. Electrical vessel contact elements 12, the number, shape and arrangement of which corresponds to the electrical contact elements 7, 8, 9, 10, 11 of the kitchen appliance 1, are arranged on the underside of the preparation vessel 5. Here, the electrical vessel contact elements 12 are formed as contact pins, which can be inserted into the electrical contact elements 7, 8, 9, 10, 11, which are formed as sockets, of the electrical interface 6 of the kitchen appliance 1. A passage opening 24, which serves for the passage of the rotating shaft 17 of the kitchen appliance 1 into the interior of the preparation vessel 5, can furthermore be seen on the underside of the preparation vessel 5. The vessel base 21 furthermore has an outer base contour, which corresponds to the shape of the guide means 16 of the receiving region 4 of the kitchen appliance 1, so that the preparation vessel 5 can be optimally aligned to the receiving region 4 of the kitchen appliance 1.

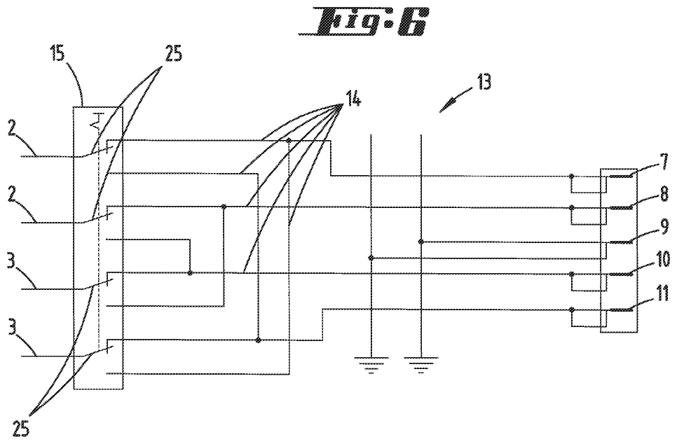

FIGS. 5A and 5B in each case show a preparation vessel 5 of a first type (FIG. 5A) and of a second type (FIG. 5B), and schematically the same electrical interface 6 of the kitchen appliance 1 comprising electrical contact elements 7, 8, 9, 10, 11, the assignment of which to certain functional means 2, 3 of the kitchen appliance 1 differs from one another, depending on the type of the connected preparation vessel 5. Viewed from left to right, the electrical interface 6 of the kitchen appliance 1 initially has electrical contact elements 10 and 11, which are assigned to a functional means 3 in FIG. 5A, namely here for example to a temperature detection means. The middle electrical contact element 9 serves for the connection of the preparation vessel 5 to an electrical protection means. The electrical contact elements 7, 8 are assigned to a different functional means 2 of the kitchen appliance 1, namely here for example to a heating means for operating a corresponding heating element of the preparation vessel 5, for example a resistance heater, which is integrated in a bottom region of the preparation vessel 5. The assignment of the electrical contact elements 7, 8, 9, 10, 11 of the kitchen appliance 1 according to FIG. 5A serves for the connection of electrical vessel contact elements 12 of the preparation vessel 5 of the first type. This type of preparation vessel 5 can be, for example, a current preparation vessel 5 of the manufacturer. In contrast, FIG. 5B shows, for example, a preparation vessel 5 of an older version, the electrical vessel contact elements 12 of which belong to other means of the preparation vessel 5. To likewise connect such a preparation vessel 5 to the same kitchen appliance 1 and to be able to optimally use all functional means 2, 3 of the kitchen appliance 1, the kitchen appliance 1 has the switch-over means 13, which is illustrated in more detail with respect to FIG. 6. The switch-over means 13 of the kitchen appliance 1 has the effect that the electrical contact elements 7, 8, 9, 10, 11 of the receiving region 4 of the kitchen appliance 1 are switched over in such a way that the connection thereof to the functional means 2, 3 corresponds to the electrical vessel contact elements 12 of the respective preparation vessel 5 of the manufacturer. The result of such a switch-over can be seen in the comparison of FIGS. 5A and 5B. In the switching state of the electrical interface 6 according to FIG. 5A, the electrical contact elements 10, 11 of the kitchen appliance 1 are assigned to the functional means 3, namely the detection means, while the electrical contact elements 7, 8 are assigned to the functional means 2, namely the heating means. After actuation of the switching element 15, the assignments between the functional means 2, 3 and the electrical contact elements 7, 8, 10, 11 are changed in such a way that the result illustrated in FIG. 5B shows. The electrical contact elements 10, 11 are thereby now assigned to the functional means 2, namely the heating means, while the electrical contact elements 7, 8 are assigned to the functional means 3, namely the detection means. The arrangement of the electrical contact elements 7, 8, 9, 10, 11 according to FIG. 5B thus corresponds, for example, to an interconnection of the electrical vessel contact elements 12 of an older version of the preparation vessel 5.

FIG. 6 shows the switch-over means 13, which serves for the switch-over of the assignment between the electrical contact elements 7, 8, 9, 10, 11 of the electrical interface 6 and the functional means 2, 3 of the kitchen appliance 1. Here, the switch-over means 13 is connected, for example, to the mechanical switching element 15 (see, for example, FIGS. 1 to 3), so that the user can effect a switch-over of connecting lines 14 of the electronic circuit by means of actuation, i.e. displacement, of the switching element 15. As illustrated in a simplified and schematic manner in FIG. 6, the displacement of the switching element 15 effects a switch-over of the electrical contact elements 7, 8, 10, 11 of the kitchen appliance, which lead to the functional means 2, 3 of the kitchen appliance 1. As can be seen in FIG. 6, the actuation of the switching element 15 (based on the illustration plane from top to bottom) effects a downward pivoting of switching contacts 25, so that the functional means 2, 3 are connected in a conductive manner to other electrical contact elements 7, 8, 10, 11 of the electrical interface 6. This relates in particular to a switch-over of the electrical contact elements 7, 8 and 10, 11. The electrical contact element 9, which establishes the connection to the grounding conductor, remains unchanged at the previous position. Due to the actuation of the switching element 15 based on the switching position illustrated in FIG. 6, the electrical assignments of the electrical contact elements 7 and 11 or 8 and 10, respectively, are evidently interchanged via the switching contacts 25. This has the result that the electrical contact elements 7, 8 of the kitchen appliance 1 are then no longer assigned to the heating means of the kitchen appliance 1 after actuation of the switching element 15, but to the detection means, on the contrary. After the switch-over, the electrical contact elements 10, 11 are assigned to the functional means 2, namely the heating means. The illustrated switch-over can also take place only partially, i.e., that, for example, only the connecting line 14 to the heating means is changed, but a switch-over of the detection means does not take place at the same time.

Even though this is not illustrated here, the switch-over means 13 is to be understood only in an exemplary manner. In the alternative, the switching element 15 can furthermore also be a switching element, which is controlled in an automated manner, for example a relay, which is switched at the receiving region 4 as a function of the result of a detection of a type or version of a preparation vessel 5. In this sense, a remote-controlled switch-over of the assignments between the electrical contact elements 7, 8, 9, 10, 11 of the kitchen appliance 1 and the functional means 2, 3 of the kitchen appliance 1 takes place. For this purpose, a sensor, which is not shown in more detail here, which can recognize the type of a preparation vessel 5 and which, as a function thereof, outputs a signal for the switch-over of the connecting lines 14, can be assigned to the receiving region 4. In the alternative, the switch-over means 13 can furthermore also be actuated manually by a user by operation of the display 18, which is preferably sensitive to touch, or of the switch 19.

Although only a few embodiments of the present invention have been shown and described, it is to be understood that many changes and modifications may be made thereunto without departing from the spirit and scope of the invention.

### List of Reference Numerals

1 kitchen appliance

2 functional means

3 functional means

4 receiving region

5 preparation vessel

6 electrical interface

7 electrical contact element

8 electrical contact element

9 electrical contact element

10 electrical contact element

11 electrical contact element

12 electrical vessel contact element

13 switch-over means

14 connecting line

15 switching element

16 guide means

17 rotating shaft

18 display

19 switch

20 handle

21 vessel base

22 cover

23 cover opening

24 passage opening

25 switching contact

What is claimed is:

1. An electrically operated kitchen appliance comprising:
at least two functional elements configured for performing a function of the kitchen appliance,
a receiving region configured for holding a preparation vessel, the receiving region having an electrical interface comprising a plurality of electrical contact elements, wherein the electrical contact elements are each connected in an electrically conductive manner to one of the functional elements of the kitchen appliance and are configured to establish an electrically conductive connection to corresponding electrical vessel contact elements of the preparation vessel, when the preparation vessel is connected to the receiving region,
a switch-over device, which is assigned to the electrical contact elements of the kitchen appliance and which is configured to change a connection assignment between the electrical contact elements of the kitchen appliance and the functional elements of the kitchen appliance in such a way that after actuation of switch-over device, at least one of the functional elements is connected to a different electrical contact element than prior to the actuation of the switch-over device.

2. The kitchen appliance according to claim 1, wherein the functional elements comprise a heating device for heating the preparation vessel, a detection device for detecting a temperature of the preparation vessel, or an electrical protection device.

3. The kitchen appliance according to claim 1, wherein the switch-over device has an electrical circuit comprising a plurality of electrical connecting lines, which connect the electrical contact elements to the functional elements in a defined changeable manner.

4. The kitchen appliance according to claim 1, wherein the switch-over device has a mechanical switching element which is configured to be manually actuated by a user of the kitchen appliance.

5. The kitchen appliance according to claim 1, further comprising a sensor for detecting a type of preparation vessel, which is connected to the electrical interface of the kitchen appliance, wherein the switch-over device is configured to switch over the connecting assignment between the electrical contact elements and the functional element as a function of the detected type of the preparation vessel.

6. The kitchen appliance according to claim 5, wherein the sensor is a contact sensor, magnetic sensor, or optical sensor.

7. The kitchen appliance according to claim 1, wherein the switch-over device has an electromagnetically acting, remote-controlled switching element in the form of a relay.

8. The kitchen appliance (1) according to claim 1, wherein the receiving region has a guide, which is configured to guide the preparation vessel to be connected to the receiving region to the electrical interface in a shape-corresponding manner.

9. The kitchen appliance according to claim 1, wherein the receiving region additionally has a rotating shaft for a force-transmitting connection to an agitator of the preparation vessel.
